(19) United States
(12) Patent Application Publication
(10) Pub. No.: US 2019/0148920 A1
(43) Pub. Date: May 16, 2019

(54) SERIES CLEARANCE MULTI-POINT DISCHARGING SPARKING PLUG

(71) Applicant: LOTUS SPARK PLUGS TECHNOLOGY (HANGZHOU) CO. LTD, Hangzhou (CN)

(72) Inventors: Helin SHEN, hangzhou (CN); Jiangtao FENG, changzhou (CN); Shiyang YANG, changzhou (CN); Lwee Chek YAN, johor (MY); Kee Foo OW, johor (MY)

(21) Appl. No.: 15/721,820

(22) Filed: Sep. 30, 2017

Related U.S. Application Data
(63) Continuation of application No. PCT/CN2015/097354, filed on Dec. 25, 2015.

(30) Foreign Application Priority Data
Apr. 7, 2015 (CN) 201510160102.4

(51) Int. Cl. H01T 13/46

(52) U.S. Cl. CPC H01T 13/46

(57) ABSTRACT

The present invention relates to a series clearance multi-point discharging spark plug for a spark ignition engine, including a wiring screw. The wiring screw is arranged in an insulator. A central electrode is arranged in a tip of the insulator. A built-in damping resistor is arranged between the central electrode and the wiring screw. A ceramic multi-point discharging ignition table fitted with the insulator is arranged at a bottom of the insulator. A cavity assembly is formed between the ceramic multi-point discharging ignition table and the insulator. An outer wall at an upper end of the ceramic multi-point discharging ignition table is fastened to the shell. An ignition electrode assembly is arranged at the bottom of the ceramic multi-point discharging ignition table. The series clearance multi-point discharging spark plug increases temperature and pressure of mixed gas during ignition, thereby improving ignition performance, shortening combustion duration and improving engine performance.

### TECHNICAL FIELD

The present invention relates to a discharging spark plug, and more specifically, to a series clearance multi-point discharging spark plug used for a spark ignition engine.

### BACKGROUND

Currently, most of spark plugs used in a spark ignition engine fueled by gasoline, gas, alcohol and the like generally include an insulator, a shell sealing gasket, a wiring nut and the like. A central electrode is arranged in the insulator, and a built-in damping resistor is taken as a positive pole of ignition through high-temperature sealing and wiring screw connection. A side electrode made of nickel alloy material is welded on a shell, and taken as a ground pole after being installed on an engine. A hooklike arcing clearance is formed between the central electrode and the side electrode. A high-voltage ignition coil is controlled to generate high-voltage pulse electric energy under an instruction of a engine management system (ECU) at an ignition time of the engine; a high-voltage breakdown electric spark is generated by a high-voltage pulse at a clearance between the side electrode and the central electrode from a high-voltage wire to the wiring screw of the spark plug (a high-voltage positive pole is directly added on the wiring screw by an independent high-voltage coil), and then, compressed mixed gas is ignited, and the detonated mixed gas is expanded to promote a piston to enable the engine to work.

Since an automobile is invented for more than 120 years, a basic form of the spark plug has no any change. Due to a limit of a structure of the spark plug and a development restriction of a traditional production technology, up to now, a discharging point could be only generated in actual work to ignite the mixed gas no matter what kind of high-technology spark plug includes a spark plug having a plurality of side electrodes. The technical distinction of all spark plugs is that some improvement is made to a material and a structure of an ignition tip, with the purpose of only prolonging the working life. Even if the so-called technical feature capable of improving the ignition performance is presented, it is relatively speaking compared with a traditional common electrode spark plug, and has no substantial technical distinction. Because the spark plug does not generate any energy at all, high-pressure energy for ignition is provided by the high-voltage coil provided by a computer, and the so-called high-energy spark plug does not exist. So far, no enterprise and individual can provide a theoretically advanced and feasible spark plug capable of multi-point ignition at intervals in an automobile industry.

Due to a structural cause of the central electrode in the insulator of the traditional spark plug, an insulator as a core part stretching into a cylinder to ignite absorbs heat by that a skirt part comes into large-area contact with high-temperature combustion gas. Heat dissipation relies on small-area contact heat conduction between a sealing gasket in a rear section of the insulator and the shell. Therefore, the spark plugs designed with different calorific values are provided in regard to engines with different requirements. Because of a restriction of an extension structure of the central electrode, the heat radiating performance of the traditional spark plug becomes a technical obstacle of the spark plug difficult to be further improved. Data displayed from an engine torque and a horsepower test can reflect that a power of any engine would be declined when outputting to a certain speed, and cannot be linearly increased all the time. Namely, the fuel is increased, and the power is reduced, with a root cause that the heat radiation of the spark plug reaches a limit value, thereby causing preignition of the engine to cause that the power is reduced. Because of ignition structures of the central electrode and the side electrode of the traditional spark plug, a nonlinear dynamic feature is an insurmountable technical barrier.

A technical development direction of a modern engine focuses on economy of combustion dynamics and strict requirements of environmental protection emission. People carry out a lot of studies on an ignition and combustion theory and practice of the engine, and especially, carry out a new-level study on a combustion mode, an ignition mode and relationships as well as a rule for power performance, fuel consumption and emission of the engine. A discharging ignition mechanism of the spark plug is divided into three processes, i.e., high-voltage breakdown, arc discharge and glow discharge. As shown in figures, actually, the spark plug only works for a very short time, but plays a crucial role for the engine combustion.

### SUMMARY OF THE PRESENT INVENTION

The present invention mainly solves defects in the prior art, provides an ignition device having compact structure and igniting mixed gas simultaneously by multiple points to shorten complete combustion time, and particularly provides a series clearance multi-point discharging spark plug as a most effective means for enhancing engine power performance on a premise of not changing other components.

The present invention solves the above technical problems through the following technical solution:

A series clearance multi-point discharging spark plug comprises a wiring screw, wherein the wiring screw is arranged in an insulator; the insulator is riveted in a shell; a central electrode is arranged in a tip of the insulator; a built-in damping resistor is arranged between the central electrode and the wiring screw; a ceramic multi-point discharging ignition table fitted with the insulator is arranged at a bottom of the insulator; a cavity assembly is formed between the ceramic multi-point discharging ignition table and the insulator; an outer wall at an upper end of the ceramic multi-point discharging ignition table is fastened to the shell; and an ignition electrode assembly is arranged at the bottom of the ceramic multi-point discharging ignition table.

The cavity assembly comprises a positive-pole high-voltage connecting cavity; the bottom of the insulator extends to the ceramic multi-point discharging ignition table; the positive-pole high-voltage connecting cavity is arranged between the bottom of the insulator and the ceramic multi-point discharging ignition table; the bottom of the central electrode extends from the insulator; the bottom of the positive-pole high-voltage connecting cavity is provided with a positive-pole high-voltage electrode connecting line fitted with the bottom of the central electrode; and the positive-pole high-voltage electrode connecting line is arranged in the ceramic multi-point discharging ignition table.

Or the cavity assembly comprises a labyrinth type positive-pole high-voltage connecting cavity and a labyrinth type positive-pole high-voltage electrode connecting line; the bottom of the insulator extends to the ceramic multi-point discharging ignition table; the labyrinth type positive-pole high-voltage connecting cavity is arranged between the bottom of the insulator and the ceramic multi-point discharging ignition table; a lug boss is arranged in a central position of the labyrinth type positive-pole high-voltage connecting cavity; the lug boss extends to the bottom of the insulator; the labyrinth type positive-pole high-voltage electrode connecting line is arranged in the central position of the lug boss; the labyrinth type positive-pole high-voltage electrode connecting line is fitted with the bottom of the central electrode; the labyrinth type positive-pole high-voltage electrode connecting line is arranged in the ceramic multi-point discharging ignition table; and the lug boss and the ceramic multi-point discharging ignition table are integrally distributed.

The ignition electrode assembly comprises a grounding electrode and a positive electrode; the positive electrode is connected with the positive-pole high-voltage electrode connecting line or the labyrinth type positive-pole high-voltage electrode connecting line; a discharging ignition clearance is formed between the grounding electrode and the positive electrode; and the grounding electrode and the positive electrode are communicated respectively through a built-in electrode connecting line.

The grounding electrode, the positive electrode, the positive electrode I, the bridging electrode and the grounding electrode I are respectively needle-shaped upright electrodes.

The built-in electrode connecting line and the built-in electrode connecting line I are arranged in the ceramic multi-point discharging ignition table.

Preferably, an outer sealing gasket is sleeved at a middle end of an outer wall of the shell; an inner sealing gasket is formed between the insulator and the shell; the inner sealing gasket is distributed obliquely; a side heat radiating contact surface is formed between the outer wall of the upper end of the ceramic multi-point discharging ignition table and the shell; a bottom heat radiating contact surface is formed between the ceramic multi-point discharging ignition table and the bottom of the shell; and a flexible sealing gasket is arranged between an upper part of the ceramic multi-point discharging ignition table and the shell.

Preferably, uniformly distributed creepage umbrella ridges are arranged at an outer wall of a lower end of the ceramic multi-point discharging ignition table; and a lower end of the ceramic multi-point discharging ignition table is cylindrical or pyramidal.

Preferably, the bridging electrode is distributed in an arc shape; a spacing of the discharging ignition clearance and a spacing of the discharging ignition clearance I are 0.3-5.0 mm (different size range is arranged based on different fuel and work condition requirement); the built-in electrode connecting line and the positive-pole high-voltage electrode connecting line or the labyrinth type positive-pole high-voltage electrode connecting line are integrally distributed; and the built-in electrode connecting line I and the positive-pole high-voltage electrode connecting line or the labyrinth type positive-pole high-voltage electrode connecting line are integrally distributed.

Preferably, two bridging electrodes are arranged; and the discharging ignition clearance I is arranged between adjacent bridging electrodes.

The ignition electrode assembly and ceramics are sintered into a whole to form the ceramic multi-point discharging ignition table, which is the core content of the patent.

To prevent high-voltage leakage, a positive-pole high-voltage connecting cavity can be configured to add a labyrinth type structure with a creep distance.

Purposes of technical improvement of the engine, such as saving energy, reducing emission of hazardous substances, guaranteeing the ignition reliability, and improving the power, are achieved by shortening the combustion time and increasing the engine combustion rate.

The engine combustion theory and practice have proved that, it takes some time from starting to discharge to ignite the mixed gas to fully detonate to work at the moment of engine ignition. In a compressed mixed gas space, the bigger the space is, the longer the time needed for complete combustion is. A current technology is to reduce the cylinder diameter and control an advance degree of the engine ignition so that the complete combustion time is in some ideal moment (generally controlled at 10-15 degrees after passing the dead point) after the engine piston passes a dead point, so that the fuel fully works. If the complete combustion time of the mixed gas of the engine can be shortened in a controlled range, the advance degree of the ignition can be reduced, so that the deflagrability of the fuel is increased, and the effective working moment is controlled in an ideal range. If a plurality of flame centers having a limited distance are generated at multiple points in a combustor simultaneously, the complete combustion time could be shortened, the deflagrability of the engine could be increased, and thus, the instantaneously controlled burst power of the engine could be improved. Therefore, when other technologies have developed to the extreme, it is undoubtedly a revolutionary advance to increase the ignition point in the cylinder, effectively shorten the complete combustion time, improve the deflagrability of the compressed mixed gas in the cylinder, and increase the combustion rate of the engine when other parts are not changed, which is a revolutionary progress.

An ignition electrode assembly is arranged in the ceramic multi-point discharging ignition table, and becomes a whole using a ceramic co-firing technology. A plurality of pairs of ignition electrodes are arranged vertically. The electrodes are connected in series to form a high-voltage discharge circuit. Multi-point synchronous discharging ignition could be realized at a clearance between the pairs of electrodes.

An ignition platform at a bottom of the insulator has a relatively small area, and a multi-point flame kernel generated by ignition and high voltage discharge at an end surface of the platform can be expanded in a semi-cylindrical shape. An ignition speed of an initial flame kernel is apparently greater than that of the traditional spark plug in a single-point discharge mode. Therefore, the combustion distance is shortened, and the complete combustion time is shortened, thereby shortening a time of generating maximum pressure in the cylinder, which is a direct gain for the power performance of the engine.

A plurality of pairs of discharge electrodes arranged vertically in parallel can break down the compressed mixed gas at a lower voltage in a creepage discharge mode among the electrodes, thereby strengthening to stimulate thermionic current to participate in combustion supporting at the moment of the high-voltage breakdown and ignition.

A long-distance non-sheltering discharging clearance is conducive to the formation of the flame kernel, and is difficult to be cooled and flame-damped by the electrode, thereby improving the initial ignition speed, and increasing the ignition rate.

Such structure is conducive to eliminating carbon deposition factors, thereby guaranteeing the ignition reliability in different working conditions.

A side heat radiating contact surface and a bottom heat radiating contact surface between the ceramic multi-point discharging ignition table and the shell adopt a welding connection type, and thus, have a good heat conducting structure, thereby guaranteeing the sealing performance of the spark plug better.

An effective thermal design spans a concept of the calorific value, so that the universality is strong.

A micro-loss precious metal discharging electrode has an infinitely long service life.

In an extremely limited space, a pair of or a plurality of pairs of series ignition electrodes are arranged at ignition end surfaces by virtue of a difference of a section size of the spark plug, to form at least two synchronous discharge clearances; and the multi-point simultaneous (the speed of electricity is far higher than the combustion speed of the flame) ignition of mixed gas having a distance difference at different positions is realized at a high-voltage ignition moment of the engine, so that the multi-point flame kernel is rapidly diffused and intersected, thereby achieving the purpose of shortening the total complete combustion time of the engine.

The ceramic multi-point discharging ignition table is made of high-performance aluminum oxide or silicon nitride ceramics. The core content of the present patent is to arrange a plurality of pairs of high-temperature-resistant discharging electrodes insulated to each other and placed vertically in the ceramic multi-point discharging ignition table. The electrodes are communicated with high-temperature-resistant alloy conductive leads. A built-in electrode connecting line and a built-in electrode connecting line I are the high-temperature-resistant alloy conductive leads respectively, or a structure of conductive connecting lines between the electrodes is manufactured with a printing and painting technology. The series high-temperature alloy leads between the discharging electrode and the electrode are sintered into a whole with the ceramic co-firing technology, thereby effectively solving the high-voltage insulation problems between the structure, strength, sealing, temperature resistance and the electrodes, and ensuring the reliability of product work. Auxiliary sealing steps are arranged in the ignition table and the shell, and a flexible heat-conducting sealing gasket is placed between the ignition table and the shell, to provide a buffer and an auxiliary seal for a mechanical connection mode of the ignition table. After the ignition table and the shell are installed and sealed, the ignition table comes into direct contact with the shell closely with a large heat conducting area, thereby greatly increasing the heat radiating function of the ceramic ignition table. A lead at a ground electrode end of the exposed grounding electrode is communicated with an end surface of the shell by welding or pressure welding, and thus, the grounding electrode of the series high-voltage ignition circuit is formed.

Each pair of precious metal electrodes at an upper end surface of the ceramic multi-point discharging ignition table is in an upright parallel creepage discharging structure. A discharging clearance between each pair of ignition electrodes is lengthened to two to three times of the spark plug in a common structure (parameters are set according to the different discharging points), so that the flame kernel with a longitudinal section is formed into a half cylinder to rapidly diffuse (the traditional spark plug spherically diffuses due to electrode depression at a single point), because it is an unidirectional open ignition mode and not affected by the structure of spark plug in an ignition and diffusion process of the flame kernel (the traditional spark plug is affected by resistance of the side electrode and the central electrode and an electrode temperature and a structure in an early stage of the flame kernel generation), and since the spark plug is easy to suffer from the flame damping effect of the electrode temperature, a defect of ignition failure is generated at an ignition stage of a combustion theory (the duty ratio is high). An outer circle of the ceramic ignition table has an insulated prismatic structure for preventing increase of the creep distance of the electrode and the shell, thereby ensuring that the high-voltage discharge is limited to occur between each pair of electrodes. A labyrinth type isolation structure is formed at a connecting point of the central electrode, to prevent the high-voltage leakage of pulse ignition.

In this structure, the ignition energy is released in a creepage breakdown discharge form, i.e., discharge is conducted along a surface of the insulator between the central electrode and the side electrode. Since the discharging distance of the hooklike structure of the central electrode and the side electrode of the traditional spark plug is short, the arcing performance is poor. Because the size of the ignition clearance is restricted by a power voltage, the ignition clearance generally is about 0.6-1.3 mm. The short discharging distance ensures that an initial spark cannot be fully “developed” into a necessary flame center, and more electric spark heat is also absorbed and cooled by the side electrode and the central electrode, thereby reducing the energy of the electric spark and generating a hidden danger of the ignition failure. If the ignition clearance is increased, the ignition voltage needs to be increased, and due to the structure of the spark plug, internal breakdown or “fire” is easily caused by voltage increase, which is an irresolvable contradiction for the traditional spark plug. The creepage discharge occurs on an interface of a ceramic surface of the insulator between each pair of upright electrodes and the mixed gas. An electric field on the ceramic surface is distorted to increase local electric field intensity under excitation of a high-voltage electric field, causing that discharge firstly occurs locally and then promoting the further development of discharge, until the whole electrode clearance is broken down. The discharge mechanism ensures that a breakdown voltage of a creepage clearance is reduced a lot than that of same-width air clearance. If the discharge distance of the creepage clearance is longer than that of an air clearance in the same breakdown voltage, the energy of the spark can be greatly improved by the long discharging distance, because the spark discharge is composed of two parts with different energy densities, i.e., a capacitor discharge part and an inductance discharge part. The former has high energy density and high voltage, and can be discharged in a very short time; and the latter has small energy density, but plays a role in a relatively long time. From the energy distribution of the electric spark, it can be seen that the energy of the inductance part is 20-30 times of that of the capacitor pat, and plays a leading role in forming the flame kernel by heating surrounding mixed gas. The longer the duration of inductance part is, the better the success rate of ignition is. If the discharging distance is prolonged, the “flame damping effect” of the side electrode can be reduced. The electric spark burns out the oil and carbon along the surface of the insulator, thereby avoiding bridging between the electrodes, also avoiding the phenomenon of current leakage due to attaching combustion deposit between the insulator and the shell, and guaranteeing the ignition reliability in an idling condition.

The practice shows that, generally, the engine can be successively ignited only with 0.2 mJ of ignition energy in the best ignition condition, and for thicker and thinner mixed gas, the ignition energy is only 3 mJ. Due to nonuniformity of gas in the cylinder and existence of turbulence, the actual ignition energy applied to the ignition coil of the engine is generally 30-50 Mj, in order to guarantee that the engine can be successfully ignited in various working conditions. All energy is released into one point in an instant. Facts prove that, the engine efficiency cannot be increased by improving the ignition energy, but the ignition reliability is improved. The improvement of kinetic energy of the engine is determined by the combustion rate of the mixed gas, and the combustion efficiency of the mixed gas mainly depends on a concentration, a temperature and a pressure of the mixed gas, as well as a turbulence speed of the mixed gas in the cylinder, is irrelevant to the size of the ignition energy, but is directly related to an ignition position and a development speed of the flame kernel. With a feature of a high-energy ignition coil of a modern automobile ignition system, this structure is more conducive to uniform release of an ignition capacity, and the ignition energy can be uniformly distributed by a first arcing clearance and a second arcing clearance or a third clearance, so that surplus energy of the ignition coil can guarantee the success rate of ignition, and can improve the combustion rate of the engine really at ignition points in different positions.

Therefore, the series clearance multi-point discharging spark plug provided in the present invention increases temperature and pressure of mixed gas during ignition, thereby improving ignition performance, shortening complete combustion duration and improving engine power efficacy.

### BRIEF DESCRIPTION OF DRAWINGS

FIG. 1 is a sectional structural schematic diagram of the present invention;

FIG. 2 is a bottom structural schematic diagram of FIG. 1;

FIG. 3 is a position distribution diagram of a single-point creepage discharging ignition electrode in the present invention;

FIG. 4 is a position distribution diagram of a double-point creepage discharging ignition electrode in the present invention;

FIG. 5 is a position distribution diagram of a three-point creepage discharging ignition electrode in the present invention;

FIG. 6 is a standard type structural schematic diagram of the present invention;

FIG. 7 is a riveting type structural schematic diagram of the present invention; and

FIG. 8 is a quick heat radiation type structural schematic diagram of the present invention.

### PREFERRED EMBODIMENTS OF THE INVENTION

Technical solutions of the present invention will be further described below in detail through embodiments in combination with drawings.

### Embodiment 1

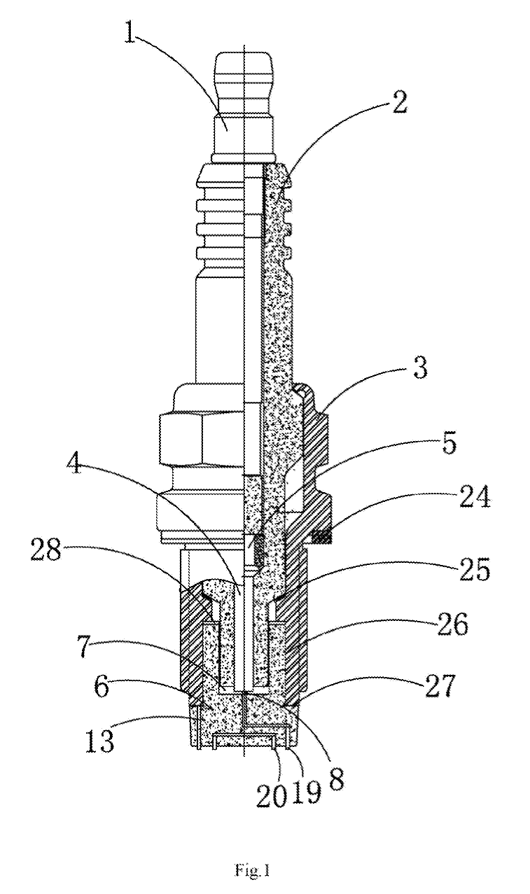

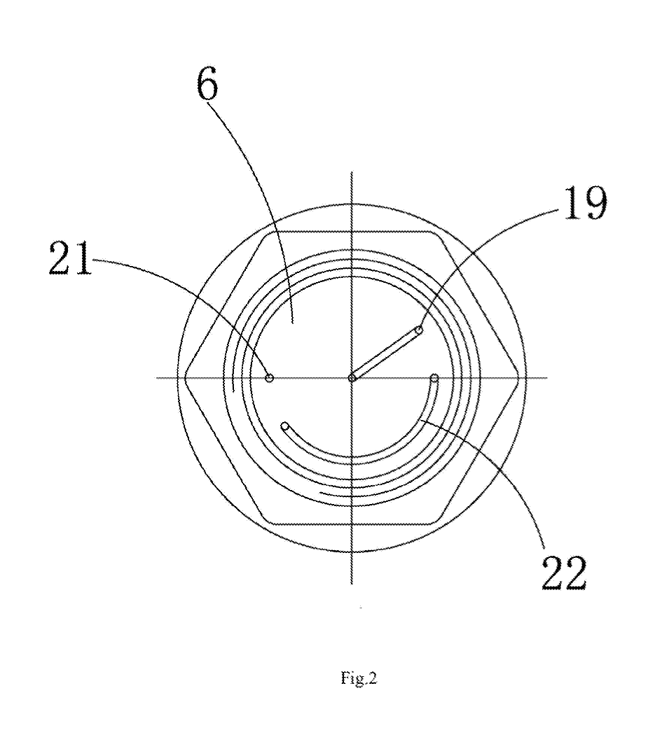

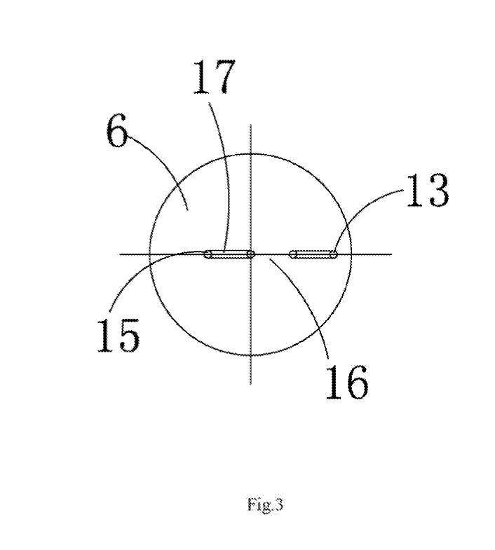

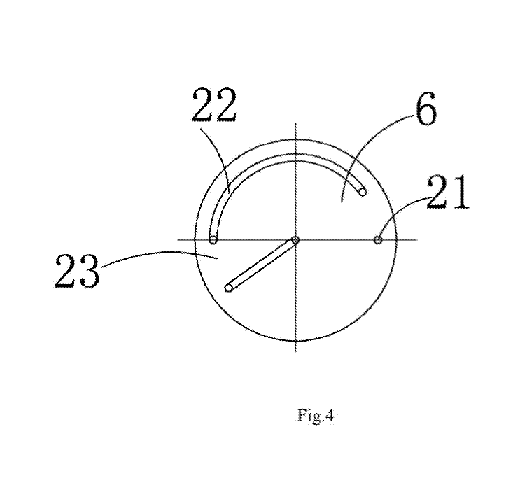

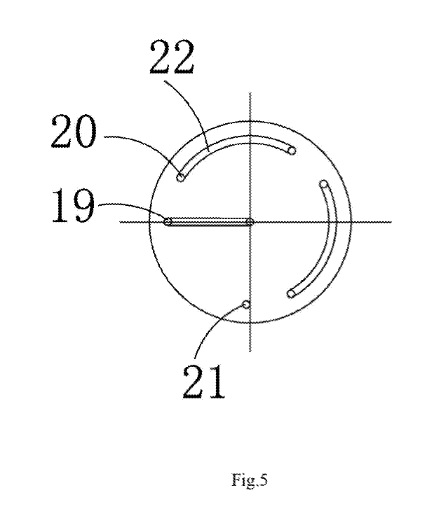

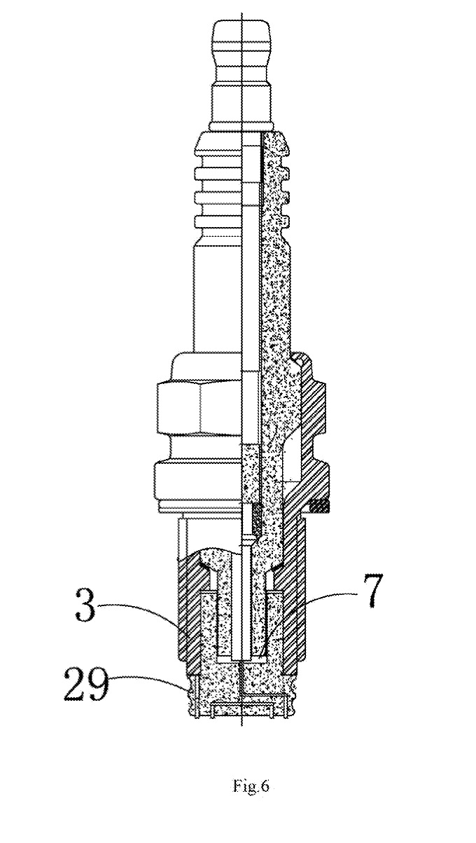

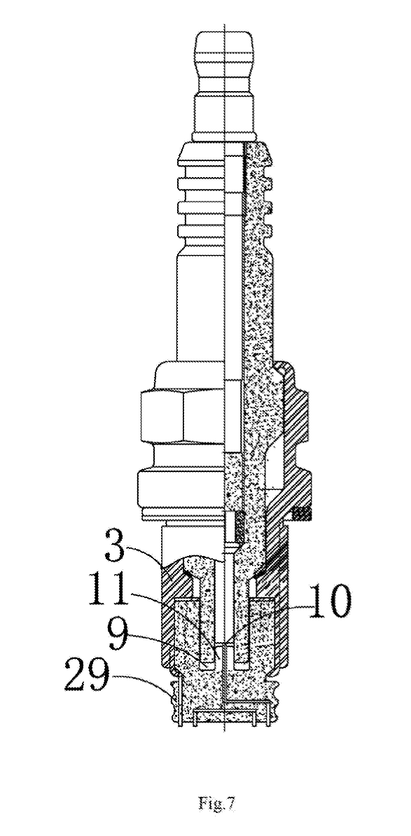

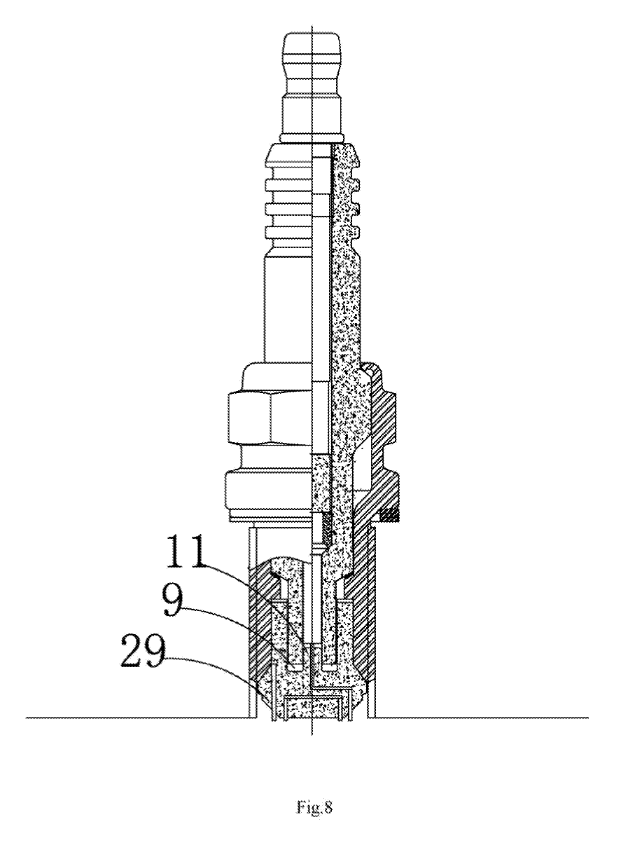

As shown in FIG. 1, FIG. 2, FIG. 3, FIG. 4, FIG. 5, FIG. 6, FIG. 7 and FIG. 8, a series clearance multi-point discharging spark plug comprises a wiring screw 1. The wiring screw 1 is arranged in an insulator 2. The insulator 2 is riveted in a shell 3. A central electrode 4 is arranged in a tip of the insulator 2. A built-in damping resistor 5 is arranged between the central electrode 4 and the wiring screw 1. A ceramic multi-point discharging ignition table 6 fitted with the insulator 2 is arranged at a bottom of the insulator 2. A cavity assembly is formed between the ceramic multi-point discharging ignition table 6 and the insulator 2. An outer wall at an upper end of the ceramic multi-point discharging ignition table 6 is fastened to the shell 3. An ignition electrode assembly is arranged at the bottom of the ceramic multi-point discharging ignition table 6. The cavity assembly comprises a positive-pole high-voltage connecting cavity 7. The bottom of the insulator 2 extends to the ceramic multi-point discharging ignition table 6. The positive-pole high-voltage connecting cavity 7 is arranged between the bottom of the insulator 2 and the ceramic multi-point discharging ignition table 6. The bottom of the central electrode 4 extends from the insulator 2. The bottom of the positive-pole high-voltage connecting cavity 7 is provided with a positive-pole high-voltage electrode connecting line 8 fitted with the bottom of the central electrode 4. The positive-pole high-voltage electrode connecting line 8 is arranged in the ceramic multi-point discharging ignition table 6. Or the cavity assembly comprises a labyrinth type positive-pole high-voltage connecting cavity 9 and a labyrinth type positive-pole high-voltage electrode connecting line 10. The bottom of the insulator 2 extends to the ceramic multi-point discharging ignition table 6. The labyrinth type positive-pole high-voltage connecting cavity 7 is arranged between the bottom of the insulator 2 and the ceramic multi-point discharging ignition table 6. A lug boss 11 is arranged in a central position of the labyrinth type positive-pole high-voltage connecting cavity 9. The lug boss 11 extends to the bottom of the insulator 2. The labyrinth type positive-pole high-voltage electrode connecting line 10 is arranged in the central position of the lug boss 11. The labyrinth type positive-pole high-voltage electrode connecting line 10 is fitted with the bottom of the central electrode 4. The labyrinth type positive-pole high-voltage electrode connecting line 10 is arranged in the ceramic multi-point discharging ignition table 6. The lug boss 11 and the ceramic multi-point discharging ignition table 6 are integrally distributed. The ignition electrode assembly comprises a grounding electrode 13 and a positive electrode 15. The positive electrode 15 is connected with the positive-pole high-voltage electrode connecting line 8 or the labyrinth type positive-pole high-voltage electrode connecting line 10. A discharging ignition clearance 16 is formed between the grounding electrode 13 and the positive electrode 15. The grounding electrode 13 and the positive electrode 15 are communicated respectively through a built-in electrode connecting line 17. Or the ignition electrode assembly comprises a positive electrode 119, at least one bridging electrode 20 and a grounding electrode I 21. The positive electrode 119 is connected with the positive-pole high-voltage electrode connecting line 8 or the labyrinth type positive-pole high-voltage electrode connecting line 10. The positive electrode 119 and the bridging electrode 20 are communicated respectively through a built-in electrode connecting line I 22. Discharging ignition clearances 123 are respectively formed between the positive electrode 119 and the bridging electrode 20 and between the grounding electrode I 21 and the bridging electrode 20. The grounding electrode 13 and the grounding electrode I 21 are respectively contacted with the shell. The built-in electrode connecting line 17 and the built-in electrode connecting line 122 are arranged in the ceramic multi-point discharging ignition table 6. An outer sealing gasket 24 is sleeved at a middle end of an outer wall of the shell 3. An inner sealing gasket 25 is formed between the insulator 2 and the shell 3. The inner sealing gasket 25 is distributed obliquely. A side heat radiating contact surface 26 is formed between the outer wall of the upper end of the ceramic multi-point discharging ignition table 6 and the shell 3. A bottom heat radiating contact surface 27 is formed between the ceramic multi-point discharging ignition table 6 and the bottom of the shell 3. A flexible sealing gasket 28 is arranged between an upper part of the ceramic multi-point discharging ignition table 6 and the shell 3.

Uniformly distributed creepage umbrella ridges (29) are arranged at an outer wall of a lower end of the ceramic multi-point discharging ignition table 6. A lower end of the ceramic multi-point discharging ignition table 6 presents cylindrical or pyramidal. The bridging electrode 20 is distributed in an arc shape. A spacing of the discharging ignition clearance 16 and a spacing of the discharging ignition clearance I 23 are 0.3-5.0 mm. The built-in electrode connecting line 17 and the positive-pole high-voltage electrode connecting line 8 or the labyrinth type positive-pole high-voltage electrode connecting line 10 are integrally distributed. The built-in electrode connecting line 122 and the positive-pole high-voltage electrode connecting line 8 or the labyrinth type positive-pole high-voltage electrode connecting line 10 are integrally distributed. Two bridging electrodes 20 are arranged. The discharging ignition clearance 123 is arranged between adjacent bridging electrodes 20.

What is claimed is:

1. A series clearance multi-point discharging spark plug, comprising a wiring screw (1); wherein the wiring screw (1) is arranged in an insulator (2); the insulator (2) is riveted in a shell (3); a central electrode (4) is arranged in a tip of the insulator (2); a built-in damping resistor (5) is arranged between the central electrode (4) and the wiring screw (1); a ceramic multi-point discharging ignition table (6) fitted with the insulator (2) is arranged at a bottom of the insulator (2); a cavity assembly is formed between the ceramic multi-point discharging ignition table (6) and the insulator (2); an outer wall at an upper end of the ceramic multi-point discharging ignition table (6) is fastened to the shell (3); an ignition electrode assembly is arranged at the bottom of the ceramic multi-point discharging ignition table (6);
the cavity assembly comprises a positive-pole high-voltage connecting cavity (7); the bottom of the insulator (2) extends to the ceramic multi-point discharging ignition table (6); the positive-pole high-voltage connecting cavity (7) is arranged between the bottom of the insulator (2) and the ceramic multi-point discharging ignition table (6); the bottom of the central electrode (4) extends from the insulator (2); the bottom of the positive-pole high-voltage connecting cavity (7) is provided with a positive-pole high-voltage electrode connecting line (8) fitted with the bottom of the central electrode (4); the positive-pole high-voltage electrode connecting line (8) is arranged in the ceramic multi-point discharging ignition table (6); or
the cavity assembly comprises a labyrinth type positive-pole high-voltage connecting cavity (9) and a labyrinth type positive-pole high-voltage electrode connecting line (10); the bottom of the insulator (2) extends to the ceramic multi-point discharging ignition table (6); the labyrinth type positive-pole high-voltage connecting cavity (7) is arranged between the bottom of the insulator (2) and the ceramic multi-point discharging ignition table (6); a lug boss (11) is arranged in a central position of the labyrinth type positive-pole high-voltage connecting cavity (9); the lug boss (11) extends to the bottom of the insulator (2); the labyrinth type positive-pole high-voltage electrode connecting line (10) is arranged in the central position of the lug boss (11); the labyrinth type positive-pole high-voltage electrode connecting line (10) is fitted with the bottom of the central electrode (4); the labyrinth type positive-pole high-voltage electrode connecting line (10) is arranged in the ceramic multi-point discharging ignition table (6); the lug boss (11) and the ceramic multi-point discharging ignition table (6) are integrally distributed;
the ignition electrode assembly comprises a grounding electrode (13) and a positive electrode (15); the positive electrode (15) is connected with the positive-pole high-voltage electrode connecting line (8) or the labyrinth type positive-pole high-voltage electrode connecting line (10); a discharging ignition clearance (16) is formed between the grounding electrode (13) and the positive electrode (15); the grounding electrode (13) and the positive electrode (15) are communicated respectively through a built-in electrode connecting line (17); or
the ignition electrode assembly comprises a positive electrode I (19), at least one bridging electrode (20) and a grounding electrode I (21); the positive electrode I (19) is connected with the positive-pole high-voltage electrode connecting line (8) or the labyrinth type positive-pole high-voltage electrode connecting line (10); the positive electrode I (19) and the bridging electrode (20) are communicated respectively through a built-in electrode connecting line I (22); discharging ignition clearances I (23) are respectively formed between the positive electrode I (19) and the bridging electrode (20) and between the grounding electrode I (21) and the bridging electrode (20); the grounding electrode (13) and the grounding electrode I (21) are respectively contacted with the shell; and the built-in electrode connecting line (17) and the built-in electrode connecting line I (22) are arranged in the ceramic multi-point discharging ignition table (6).

2. The series clearance multi-point discharging spark plug according to claim 1, wherein an outer sealing gasket (24) is sleeved at a middle end of an outer wall of the shell (3); an inner sealing gasket (25) is formed between the insulator (2) and the shell (3); the inner sealing gasket (25) is distributed obliquely; a side heat radiating contact surface (26) is formed between the outer wall of the upper end of the ceramic multi-point discharging ignition table (6) and the shell (3); a bottom heat radiating contact surface (27) is formed between the ceramic multi-point discharging ignition table (6) and the bottom of the shell (3); and a flexible sealing gasket (28) is arranged between an upper part of the ceramic multi-point discharging ignition table (6) and the shell (3).

3. The series clearance multi-point discharging spark plug according to claim 1, wherein uniformly distributed creepage umbrella ridges (29) are arranged at an outer wall of a lower end of the ceramic multi-point discharging ignition table (6); and a lower end of the ceramic multi-point discharging ignition table (6) is cylindrical or pyramidal.

4. The series clearance multi-point discharging spark plug according to claim 2, wherein uniformly distributed creepage umbrella ridges (29) are arranged at an outer wall of a lower end of the ceramic multi-point discharging ignition table (6); and a lower end of the ceramic multi-point discharging ignition table (6) is cylindrical or pyramidal.

5. The series clearance multi-point discharging spark plug according to claim 1, wherein the bridging electrode (20) is distributed in an arc shape; a spacing of the discharging ignition clearance (16) and a spacing of the discharging ignition clearance I (23) are 0.3-5.0 mm; the built-in electrode connecting line (17) and the positive-pole high-voltage electrode connecting line (8) or the labyrinth type positive-pole high-voltage electrode connecting line (10) are integrally distributed; and the built-in electrode connecting line I (22) and the positive-pole high-voltage electrode connecting line (8) or the labyrinth type positive-pole high-voltage electrode connecting line (10) are integrally distributed.

6. The series clearance multi-point discharging spark plug according to claim 2, wherein the bridging electrode (20) is distributed in an arc shape; a spacing of the discharging ignition clearance (16) and a spacing of the discharging ignition clearance I (23) are 0.3-5.0 mm; the built-in electrode connecting line (17) and the positive-pole high-voltage electrode connecting line (8) or the labyrinth type positive-pole high-voltage electrode connecting line (10) are integrally distributed; and the built-in electrode connecting line I (22) and the positive-pole high-voltage electrode connecting line (8) or the labyrinth type positive-pole high-voltage electrode connecting line (10) are integrally distributed.

7. The series clearance multi-point discharging spark plug according to claim 1, wherein two bridging electrodes (20) are arranged; and the discharging ignition clearance I (23) is arranged between adjacent bridging electrodes (20).

8. The series clearance multi-point discharging spark plug according to claim 2, wherein two bridging electrodes (20) are arranged; and the discharging ignition clearance I (23) is arranged between adjacent bridging electrodes (20).
